(19) United States
(12) Patent Application Publication
(10) Pub. No.: US 2011/0185721 A1
(43) Pub. Date: Aug. 4, 2011

(54) ENERGY CONVERSION DEVICE

(75) Inventor: Donald Milne Turner, Bath (GB)

(73) Assignee: AWS Ocean Energy Limited, Inverness (GB)

(21) Appl. No.: 12/992,697

(22) PCT Filed: May 13, 2009
(86) PCT No.: PCT/GB09/01195

§ 371 Date: Apr. 14, 2011

(30) Foreign Application Priority Data
May 13, 2008 (GB) 0808667.0

(51) Int. Cl. F03B 13/18

(52) U.S. Cl. 60/504

(57) ABSTRACT

An energy conversion device, such as a wave energy conversion device has a diaphragm (30) attached to a frame (100, 110) with opposed lateral edges of the diaphragm (30) being attached to the frame (100, 110) with an “S”-shaped configuration. The diaphragm (30) and frame (100, 110) form a cell (20) for fluid which is driven by movement of the diaphragm to drive a power-take-off device such as a turbine mounted in a duct leading from the cell (20). The diaphragm may be reinforced by cords, preferably vertical cords. Multiple cells (20) may be arranged in a ring, or the duct from one cell may lead to a reservoir or to another cell.

The present invention relates to S-shaped diaphragms which, in use, may separate two fluids.

The present invention also relates to energy conversion devices, in particular energy conversion devices which convert fluctuations in a fluid on one side of a diaphragm to fluctuations in another fluid on the other side of the diaphragm. In a preferred arrangement it relates to wave energy conversion devices which transmit the energy generated by waves to a body of air or other fluid in order to drive a power take off device such as a turbine.

There are several types of known wave energy converter devices which exploit the energy generated by the rise and fall of the sea's surface caused by waves. The most efficient of these devices use air as an intermediary medium. In such devices energy is collected from a large area and conducted to a duct of relatively small diameter so that a turbine is driven at a high rotational speed. In comparison, a system which collects energy directly from water will have higher energy losses at each change of cross-sectional area due to the higher density and consequent inertia of the water. Also, water turbines are slower running than air generators, and have to be geared up to drive a generator.

The most common wave energy conversion devices are of the oscillating water column (OWC) type, which use the rise and fall of the sea's surface to force a trapped volume of air through a Wells turbine. A disadvantage of such devices is that they are resonant and are generally fixed to the shore or sea bed. Also, the number of shoreline sites able to support such a device is limited.

Of the known deep water wave energy converter devices, one of the most efficient is considered to be the floating CLAM device, as described in “The Clam wave energy converter”, F. P. Lockett, Wave Energy Seminar, Institute of Mechanical Engineers, London, November 1991, pp. 19-23. This is a rigid floating toroidal device consisting of interconnected air cells with rectangular flexible diaphragms. The device is moored offshore, and wave action causes air to be forced back and forth between cells. This air flow is used to drive Wells turbines coupled to generators.

One part of the present invention is concerned with a diaphragm structure. In this first part, a diaphragm used to separate two fluids is connected to a support structure along an S-shaped line.

Thus, the present invention may provide a device comprising a deformable diaphragm and a support structure for that diaphragm, the diaphragm being configured to be arranged between first and second fluids and, in use, being deformable to act on one of those fluids;

wherein at least part of the diaphragm is secured to the support structure along a line of attachment, which line of attachment is S-shaped.

Preferably, the diaphragm is mounted at the support structure so that two opposed edges both have the S-shaped configuration, so it has a line of attachment which is S-shaped to the support structure. The support structure may then be a frame, which together with a diaphragm forms a cell for one or other of the fluids.

The fluids will normally, but not necessarily, be different, such as air and water, but the present invention is not limited to those specific fluids.

Such a diaphragm arrangement may be used in an energy conversion device, such as a wave energy conversion device. The energy conversion device may comprise a power take-off device operable by the first or second fluid. Such an energy conversion device represents a second part of this invention. Of course, the first and second parts may be used in combination.

The present invention is also concerned with an energy conversion device in which a diaphragm is supported by a frame, and changes to a fluid on one side of the diaphragm are transmitted to another fluid in a cell defined by the frame and the diaphragm. The present invention has various aspects, concerned with the configuration and structure of the diaphragm. The first aspect of the invention is concerned with the attachment of the diaphragm to the frame. In this aspect, two opposed edges of the diaphragm are attached to the frame so as to define an ‘S’-shaped configuration.

Thus, according to a first aspect of the second part of the present invention, there may be provided:

an energy conversion device, including:

a diaphragm supported by a frame, the frame and diaphragm together defining a cell for fluid;

a duct extending from the cell; and

a power-take-off device associated with the duct and arranged to respond to fluctuation of the fluid in the cell and/or duct;

wherein the diaphragm is capable of changing shape in response to a change in pressure difference across the diaphragm, the change of shape causing a consequent change in the fluid in the cell, and hence a response in the power-take-off device, a pair of opposite edges of the diaphragm being attached to the frame in a S-shaped configuration.

It may be noted that, in such an arrangement, the S-shaped configuration may define the line of attachment of the diaphragm to the frame, as in the first part of this invention.

The power-take-off device is preferably a turbine, which is driven to rotate by fluid flow through the duct. However, other power-take-off devices may be used, such as pistons which are mounted in the duct and are forced to move by fluid movement resulting from change in shape of the diaphragm.

Whilst the duct may have a cross-sectional size significantly smaller than the face of the cell from which it extends, it is possible for the duct to be the same cross-sectional area (or substantially similar cross-section area) to that face of the cell, so that the duct is then a continuation of the cell. This is particularly appropriate when a piston arrangement is used for the power-take-off device, with a large piston being driven by the fluid in the cell, which large piston is connected to a smaller piston from which the power is extracted.

It is preferable that the fluid in the cell is air, although it is also possible to use other gases, or even liquids. The fluid in the cell may be the same or different from the fluid on the other side of the diaphragm from the cell.

The present invention has particular applications in a wave energy conversion device, in which waves interact with one side of the diaphragm, to cause the diaphragm to move, and thus move air in an air cell defined by the diaphragm and frame. In a wave energy conversion device, the orientation of the device will normally be such that the “S”-shaped edges of the diaphragm are vertical (upright in use).

Thus, in a preferred development of the first aspect, there may be provided:
a wave energy conversion device, including:

a diaphragm supported by a frame, the frame and diaphragm together defining an air cell;

an air duct in fluid communication with the air cell; and

a turbine arranged to rotate in response to an air flow through the air duct,

wherein the diaphragm is capable of changing shape in response to a change in a pressure difference across the diaphragm caused by wave action, the change of shape causing air to be forced between the air cell and the air duct such that an air flow is generated in the air duct and the turbine is caused to rotate, vertical edges of the diaphragm being attached to the air cell in an ‘S’-shaped configuration.

The skilled reader will understand that the term ‘wave’ as used herein does not merely include the fluid movement at the surface of a body of water observed during the travel of a wave, but also includes the movement of the particles of water beneath the surface. Each wave is formed by a cyclical movement of the particles of water, and it is this cyclical movement (which is roughly circular in deep water) which causes the observed surface movements. Thus, as a result of the cyclical movement the passing of a wave through a body of water causes a change in the surface level of the water and also a change in the distribution of pressure through the body of water. Thus, in the present invention, the diaphragm interacts with either or both of the surface level and the distribution of pressure through the body of water. The variation of each causes a pressure change across the diaphragm.

In use, when the device is submerged in a body of water, either fully or so that most of its height is submerged, at any point in time the pressure of the air on the inside of the diaphragm is constant over its height while the pressure of the water increases with depth. The effect of this is that the diaphragm is deformed so that a vertical cross-section through it is ‘S’-shaped. When a wave passes the device the change in water level and pressure distribution causes a change in pressure across the diaphragm which then causes the diaphragm to move. This process repeats at a frequency of about 0.05 Hz to 0.5 Hz. This movement is both ‘in and out’ and also, at the mid-region of the diaphragm at least, ‘up and down’. The movement of the diaphragm causes an air flow to be set up through the air duct, and consequently across the turbine.

The device may be a floating deep sea device or may be a fixed deep sea or near shore device. In embodiments in which the device is fixed, it may be fixed to a rigid structure such as a jetty, wind turbine tower or tidal stream tower. The device may be fixed such that the diaphragm is fully or partly submerged during all or part of the tidal range.

In use, the diaphragm separates water from air at a vertical or at an angle of 40 degrees or less from the vertical.

The size of the diaphragm is determined by the size of the wave energy device. Typically, a larger diaphragm may be approximately 8 m high by 14 m wide. Smaller diaphragms may be about half that size.

In order to be able to change shape in response to wave action while minimising energy losses due to deformation the diaphragm must be longer in the vertical direction than the aperture it covers. The diaphragms of the known CLAM device are reinforced with cords arranged in a bias pattern and are attached to their respective air cells via a straight-sided frame. The bias of the cords enables the vertical height of the diaphragm to be reduced at its edges by lateral stretching of the diaphragm, thus allowing the diaphragm to be fitted to the frame. However, the present inventors have established that this manipulation of the diaphragm leads to energy losses as a result of the in-built strains. By attaching the edges of the diaphragm in an ‘S’-shaped configuration and employing a diaphragm with a length in the vertical direction which is the same as, or close to, the length of the ‘S’-shape, the length of the diaphragm in the vertical direction can be longer than the height of the aperture the diaphragm covers. In addition, such an arrangement is easy to assemble and ensures that lateral strains, and the consequent energy losses, can be reduced and most importantly that diagonal strains are accommodated.

In preferred embodiments the length of the diaphragm is about 20% longer than the vertical height of the frame to which the diaphragm is attached (i.e. the height of the aperture the diaphragm covers). For example, it is contemplated that a diaphragm which is 11.5 m long in the vertical direction would suit a frame of 9.5 m in height.

In preferred embodiments the ‘S’-shaped configuration approximates the shape of a vertical cross-section of the diaphragm mid-way between its vertical edges when the converter is in use and the pressure difference across the diaphragm is constant, e.g. in a calm sea. This shape can also be thought of as the ‘neutral position’ of the diaphragm in which lateral strains can be minimised.

To achieve the maximum reduction in lateral strains and consequent energy losses, the diaphragm should preferably be at least 5% wider than it is high, or more preferably at least 10% wider than it is high. The diaphragm may be 40% or even 50% wider than it is high. Movement of the centre region of the diaphragm is largely controlled by the vertical cords, so there is little extension and subsequent energy loss here. Thus the wider the diaphragm is, the smaller (in relative terms) the proportion of the area subjected to lateral strains. The term “width” is used here to refer to the dimension of the diaphragm in the lateral direction. A width of about 14 m is considered by the inventors to be desirable.

The thickness of the diaphragm may vary across its width. At the edges of the diaphragm which have the “S”-shaped configuration the diaphragm may be thicker than at intermediate parts between those edges. The central part (the region equidistant from the edges) may be thinnest. Preferably the edges are at between 4 and 12 times thicker than the central part, more preferably between 5 and 10 times. The thickness at the edges may taper regularly toward the central part, or there may be a thick region extending away from the edges (by 5 to 15% of the width of the diaphragm) which then tapers to the central region.

The second aspect of the second part of the present invention is concerned with one possible structure for the diaphragm. In this second aspect, the diaphragm is reinforced with a plurality of first cords, aligned in a predetermined direction. Where the second aspect is used in a wave energy conversion device, the cords are aligned with a vertical plane.

Thus, the second aspect of the present invention may provide:

an energy conversion device, including:

a diaphragm supported by a frame, the frame and diaphragm together defining a cell for fluid;

a duct extending from the cell; and

a power-take-off device associated with the duct and arranged to respond to fluctuation of the fluid in the cell and/or duct;

wherein the diaphragm is capable of changing shape in response to a change in pressure difference across the diaphragm, the change of shape causing a consequent change in the fluid in the cell, and hence a response in the power-take-off device, the diaphragm reinforced with a plurality of first cords aligned in a predetermined direction.

Other optional features of the second aspect may correspond to optional features of the first aspect.

As a development of this aspect, when used in a wave energy conversion device, the second aspect may provide:

a wave energy conversion device floating on a body of water or fixed in space, the device including:

a diaphragm supported by a frame, the frame and diaphragm together defining an air cell;

an air duct in fluid communication with the air cell; and

a turbine within the air duct, the turbine being arranged to rotate in response to an air flow through the air duct,

wherein the diaphragm is fully or partially submerged in the water and is capable of changing shape in response to a change in a pressure difference across the diaphragm caused by wave action, the change of shape causing air to be forced between the air cell and the air duct such that an air flow is generated in the air duct and the turbine is caused to rotate, the diaphragm being reinforced with a plurality of first cords aligned with a vertical plane.

Such an arrangement enables the diaphragm to resist buoyancy (the dominant force in determining the shape of the diaphragm) in the vertical direction.

Where the diaphragm is reinforced with cords in this way, the density of the cords within the diaphragm may vary across the diaphragm between the vertical edges. The density at the edges may be lass than at the central zone, so that it is 70% or less.

In preferred embodiments the diaphragm is reinforced with a second elongate reinforcing means aligned with a horizontal plane. Such an arrangement allows the diaphragm to be sufficiently stretchy in the lateral direction to allow the diaphragm to assume a smooth curved form during operation while avoiding undue energy losses. The second reinforcing means also serves to absorb lateral forces generated in the diaphragm. The second reinforcing means may comprise a plurality of second cords or a strip of material such as rubber. In embodiments where the second reinforcing means comprises a reinforcing strip a rubber strip of about 0.5-1 m wide is desirable for a 14 m wide diaphragm.

The first cords may be substantially inextensible and/or have a higher tensile strength than the second reinforcing means. Thus, maximum energy transfer can be achieved, since the forces generated by the pressure difference can be contained by resisting tension in the vertical direction. A particularly suitable material for the first material is Kevlar™, or other para-aramid, polyaramid or aramid synthetic fibre. In embodiments where the second reinforcing means comprises a plurality of second cords, those cords may have a lower tensile strength and/or a lower elastic modulus than the first cords. In this way, a small lateral stretch in the diaphragm can be accommodated, necessary for the vertical cords to take up their desired shapes. A particularly suitable material for the second cords is nylon.

The first and second cords may be arranged in a warp knit weft insert fabric. The second cords may extend over the entire width of the diaphragm to reach the vertical attachment clamps, or they may terminate some distance from the edge. This distance may be typically 1 m in applications where the diaphragm is several metres in height and width, for example 8 m by 14 m.

The third aspect of the invention develops the idea of having multiple reinforcement to the diaphragm, and at its most general proposes the diaphragm is reinforced with a plurality of first cords and second elongate reinforcing means arranged at an angle to the first chords, the second reinforcement means have a lower strength than the first cords. The second reinforcing means may be cords.

Thus, in this aspect, there may be provided:

an energy conversion device, including:

a diaphragm supported by a frame, the frame and diaphragm together defining a cell for fluid;

a duct extending from the cell; and

a power-take-off device associated with the duct and arranged to respond to fluctuation of the fluid in the cell and/or duct;

wherein the diaphragm is capable of changing shape in response to a change in pressure difference across the diaphragm, the change of shape causing a consequent change in the fluid in the cell, and hence a response in the power-take-off device, the diaphragm being reinforced with a plurality of first cords and a second elongate reinforcing means arranged at an angle to the first chords, the second reinforcing means having a lower tensile strength than the first cords.

Alternatively, and/or in addition, the first cords are substantially inextensible and/or the second reinforcing means has a lower modulus of elasticity than the first cords.

Again, other optional features of the third aspect may correspond to the optional feature of the first aspect.

When applied to wave energy conversion device, this aspect may provide: a wave energy conversion device, including:

a diaphragm supported by a frame, the frame and diaphragm together defining an air cell;

an air duct in fluid communication with the air cell; and

a turbine within the air duct, the turbine being arranged to rotate in response to an air flow through the air duct,

wherein the diaphragm is capable of changing shape in response to a change in a pressure difference across the diaphragm caused by wave action, the change of shape causing air to be forced between the air cell and the air duct such that an air flow is generated in the air duct and the turbine is caused to rotate, the diaphragm being reinforced with a plurality of first cords and a second elongate reinforcing means arranged at an angle to the first cords, the second reinforcing means having a lower tensile strength than the first cords.

Alternatively, and/or in addition, the first cords are substantially inextensible and/or the second reinforcing means has a lower modulus of elasticity than the first cords.

In some embodiments the second reinforcing means comprises a plurality of second cords, which are preferably aligned with one another. In other embodiments the second reinforcing means comprises a reinforcing strip which is preferably made of rubber or other suitable material.

For maximum energy transfer the diaphragm must react freely to the pressure changes over as much as possible of its width, and absorb as little energy as possible through hysteresis. The present inventors have determined, in part through computer modelling techniques, that in use the diaphragm needs to have different properties in different directions. In one direction the diaphragm must resist high tensile strains, and in the other direction it must resist lower tensile strains while at the same time allowing for some stretch in that direction. Thus, the diaphragm is arranged so that in use the first cords are aligned with the former direction and the second reinforcing means (second cords) are aligned with the latter direction.

Preferably, when the device is in use the first cords are aligned with a vertical plane. Such an arrangement enables the diaphragm to resist buoyancy (the dominant force in determining the shape of the diaphragm) in the vertical direction. Additionally, the second cords are preferably aligned with a horizontal plane when the device is in use. Such an arrangement allows the diaphragm to be sufficiently stretchy in the lateral direction to allow the diaphragm to assume a smooth curved form during operation while avoiding undue energy losses.

Thus, the diaphragm is reinforced in one direction (preferably the vertical direction when the device is in use) by cords with a high stiffness and/or a high tensile strength and in another direction (preferably the horizontal or lateral direction when the device is in use) by cords with a lower stiffness and/or a lower tensile strength. The diaphragm is therefore able to stretch more in the latter direction than the former direction.

The angle between the first and second cords is non-zero. In preferred embodiments the angle is 80 degrees or more or more preferably 85 degrees or more. In preferred embodiments the angle is 100 degrees or less or more preferably 95 degrees or less. Most preferably, the first and second cords are arranged so that they are orthogonal. Arranging the first and second cords at right angles to one another enables diagonal strains to be accommodated by pantographing of the cords. The selected angle may be within a range of plus or minus 10 degrees. Particularly suitable materials for the first cords include Kevlar™, or other para-aramid, polyaramid or aramid synthetic fibre, and steel. Particularly suitable materials for the second cords include nylon and Lycra™ or Lycra™ derivatives. The first and second cords may be arranged in a warp knit weft insert fabric.

In preferred embodiments, incorporating any of the aspects, the diaphragm will normally be partially submerged so that 10% or more and/or 20% or less of its height is exposed above the waterline. The non-submerged portion of the diaphragm is known as freeboard. It is also envisaged that embodiments of the device will be submerged so that the diaphragm has less than 10% freeboard, or even may be fully submerged so that there is no freeboard. Thus, the device may be fixed to rigid structures in conditions in which tidal ranges or changing atmospheric conditions affect the water level. It is contemplated that changes of water level of about 2 m or even 5 m may be accommodated in this way. In embodiments in which the freeboard varies as a result of tidal activity or atmospheric pressure it is envisaged that the pressure maintained within the air cell will be adjusted to maximise the performance of the device.

In any of the first, second or third aspects, each air cell may include more than one diaphragm at a wave incident side. For example, two diaphragms may be arranged side-by-side, each supported by a common support member.

Devices according to any of the first, second or third aspects may include two or more air cells arranged side-by side. Alternatively, or in addition, each device may include two or more (preferably two or three) air cells stacked vertically. Wave energy reduces with depth from the surface of the sea; for example, it has been determined that wave energy at about 15 m below the surface of the sea will be in the region of half that at the surface itself. However, it may nonetheless be economic in some locations to arrange air cells in a stack so that the air cell at the top of the stack being either partially or completely submerged and the one or more remaining air cells are completely submerged.

Fourth, fifth, sixth and seventh aspects of the present invention are provided by combinations of the first, second and third aspects. Thus, in the fourth and fifth aspects the diaphragm of the device according to the first or second aspects, respectively, may be attached to the air cell in an ‘S’-shaped configuration. In the sixth aspect the diaphragm of the device according to the third aspect may be reinforced with a plurality of first cords and a second reinforcing means arranged at an angle to the first cords, the second reinforcing means having a lower tensile strength than the first cords. Similarly, in the seventh aspect the diaphragm of the device according to the third aspect may be reinforced with a plurality of first cords aligned with a vertical plane when the device is in use.

In embodiments in which the first aspect is combined with either the second or third aspect there are particular advantages to the ‘S’-shaped attachment configuration as it is not possible to manipulate the diaphragm so that it fits to a straight-sided frame while still ensuring that the diaphragm is taller than the aperture which it covers. However, in the second and third aspects, whilst the ‘S’-shaped configuration is preferred it may alternatively be a sinusoidal curve.

In embodiments of any of the first to seventh aspects the duct may connect the cell to a large compensation chamber, or reservoir. In such embodiments, when used as a wave energy conversion device the cell will typically be fixed to a fixed structure such as a harbour wall, jetty, wind turbine tower or

tidal stream tower, i.e. the air cell will be fixed in space. The cell (normally an air cell) responds to waves incident on the diaphragm in the manner described above, so that when a wave peak arrives at the diaphragm air is discharged through the turbine within the air duct and into the compensation chamber. This process causes the pressure within the chamber to increase so that when a wave trough arrives a the diaphragm, the air in the compensation chamber is at a higher pressure than that in the air cell and so flows back through the turbine in order to refill the air cell.

In other embodiments, the duct may connect the cell to one or more other cells. Thus, a device according to any of the aspects may include a plurality of diaphragms each supported by a frame, the frames and diaphragms together defining a plurality of cells (e.g. air cells) in fluid communication with the duct, wherein each of the diaphragms is capable of changing shape in response to a change in a pressure difference across the diaphragm caused by wave action, the change of shape causing fluid (e.g. air) to be forced between its respective cell and the duct such that an flow is generated in the air duct and the turbine is caused to rotate, or the flow drives another power-take-off device

Differential wave action across each of the cells causes fluid to be pumped back and forth between the cells. This flow turns the turbine, or drives another power-take-off device which may be connected to one or more generators to thereby generate electricity.

In some embodiments the device may include a plurality of turbines within the duct, each turbine being arranged to rotate in response to an air or other fluid flow through the duct.

In embodiments in which the device is a floating deep sea device the plurality of air cells may be arranged in a torus, or ring, and the air duct in the form of a ring to which each of the air cells is connected. This has been found to be an efficient arrangement of the air cells. Such a device preferably includes twelve air cells.

The device may include a reservoir in fluid communication with the plurality of cells via the duct. In use, where the fluid used is air, the reservoir is preferably maintained at a pressure higher than the atmospheric pressure and lower than the mean pressure in the sea at the base of the diaphragm. More preferably, the reservoir is maintained at a pressure approximately midway between these pressure levels.

In other embodiments the plurality of cells may be arranged in series in the direction of the principal wave direction. For example, the cells may be arranged along a fixed structure such as a jetty, wind turbine tower or tidal stream tower. Typically, the cells will be separated by a distance related to the wavelength of the incident waves. In preferred embodiments the cells will be separated by a distance equivalent to half the wavelength of the incident waves. In other embodiments the separation distance may be a quarter of the wavelength or more and/or three quarters of the wavelength or less. As a result of the series arrangement the cells experience differential wave action and is exchanged between the cells so that a flow of fluid such as air is set up through the air duct.

In the devices according to any of the aspects, the or each turbine may be a Wells turbine. Wells turbines are able to rotate in a forward sense in response to air flows in either direction. They are therefore suitable for directly driving electrical generators without the need for rectification of the air flow.

Preferred and/or optional features of any aspect of the invention may be applied to any other aspect in any combination or sub-combination, unless the context demands otherwise.

Embodiments of the invention will now be described by way of example and with reference to the accompanying drawings, in which:

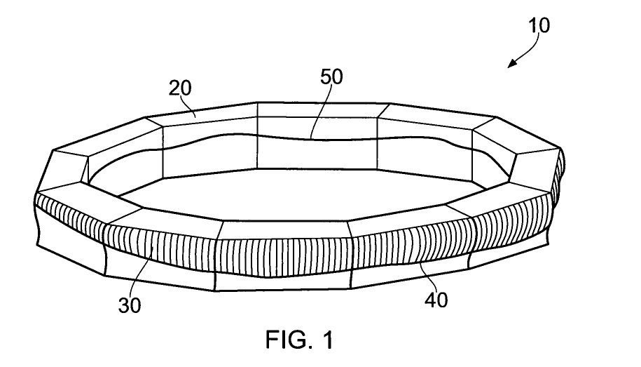

FIG. 1 is a plan view of a wave energy conversion device according to a first embodiment of the present invention;

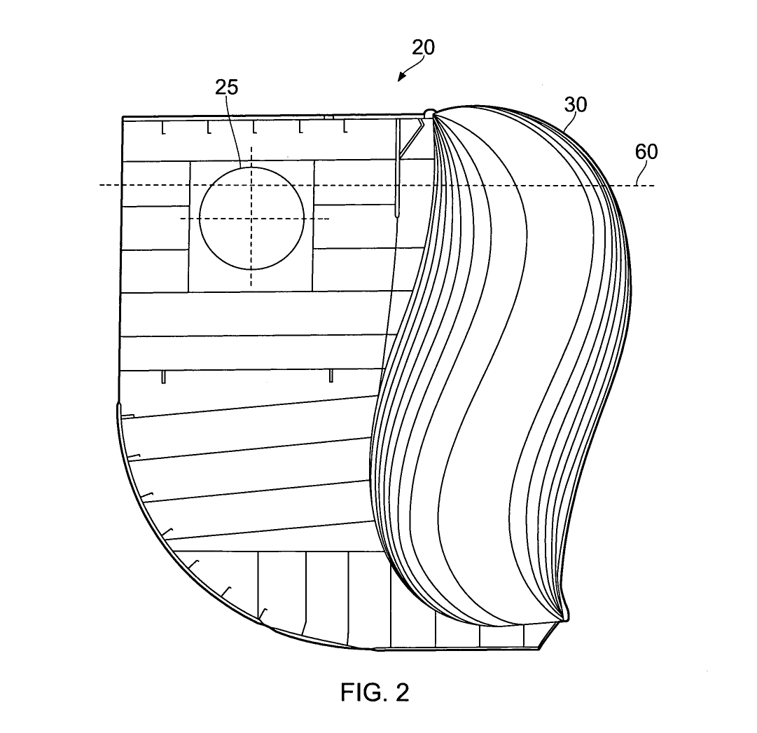

FIG. 2 is a cross-sectional view of a prior art wave energy conversion device;

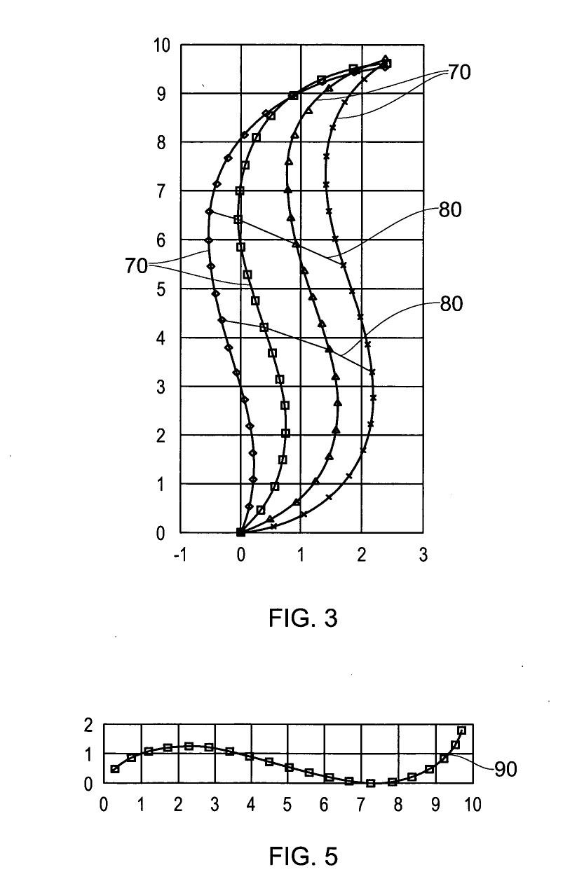

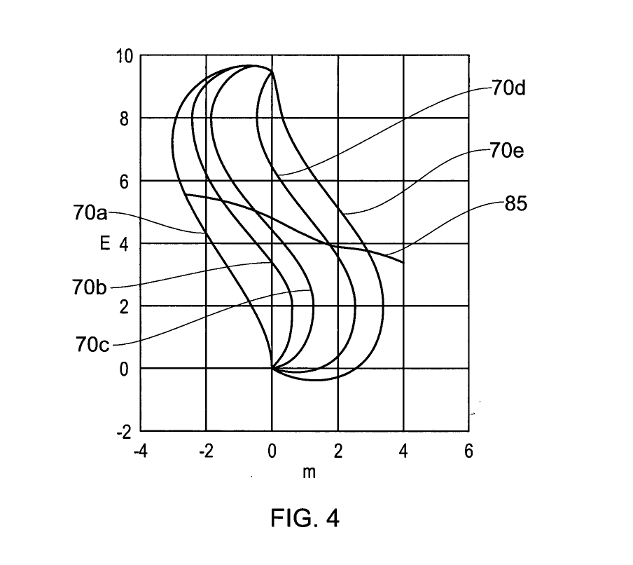

FIGS. 3 and 4 are diagrams showing plots of the shape of the diaphragm of devices according to the present invention in various stages of the operation cycle;

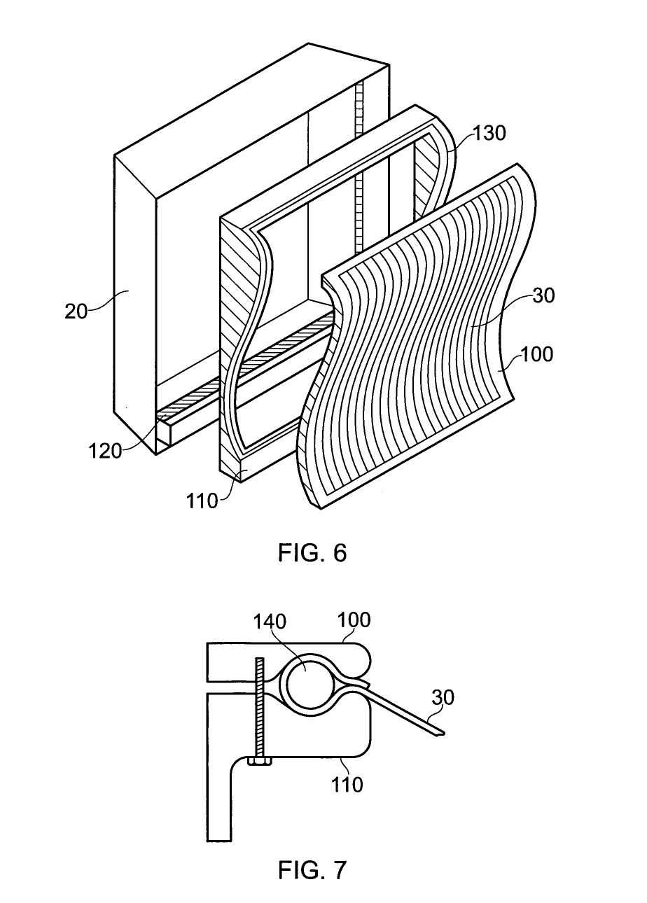

FIG. 5 is a diagram showing the computed shape of an attachment frame for the vertical edges of the diaphragm of a device according to the present invention;

FIG. 6 is an exploded perspective view showing the attachment between the diaphragm and air cell of a wave energy conversion device according to the present invention;

FIG. 7 is a cross-sectional view showing the attachment between the diaphragm and air cell of a wave energy conversion device according to the present invention;

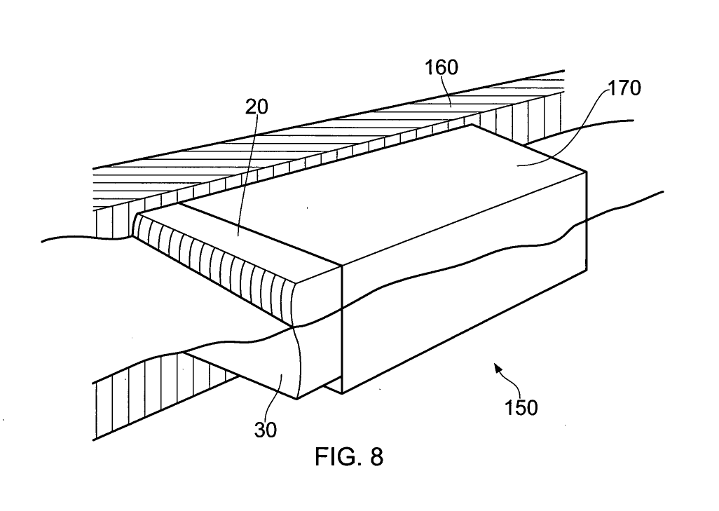

FIG. 8 is a perspective view of a wave energy conversion device according to a second embodiment of the present invention;

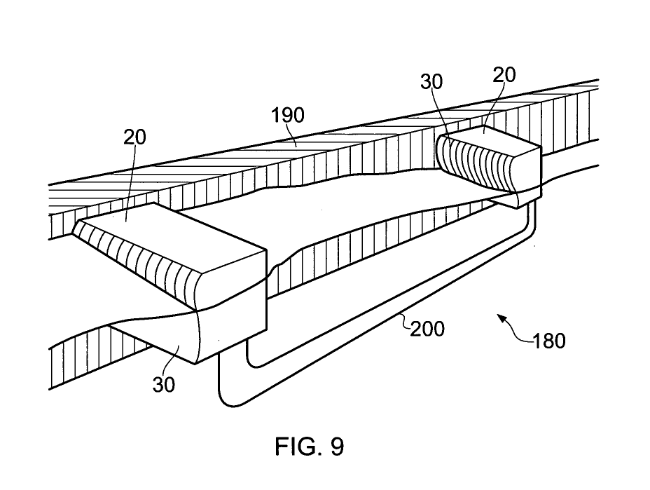

FIG. 9 is a perspective view of a wave energy conversion device according to a third embodiment of the present invention;

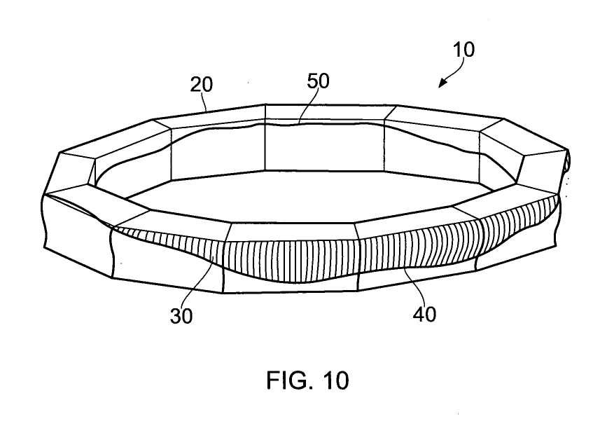

FIG. 10 is a perspective view of a wave energy conversion device according to a fourth embodiment, being similar the first embodiment of FIG. 1;

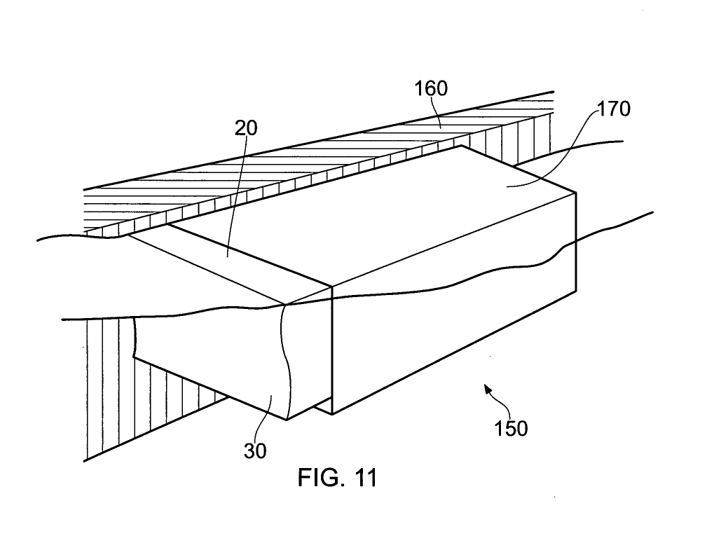

FIG. 11 is a perspective view of a wave energy conversion device according to a fifth embodiment of the present invention, being similar to the embodiment of FIG. 8;

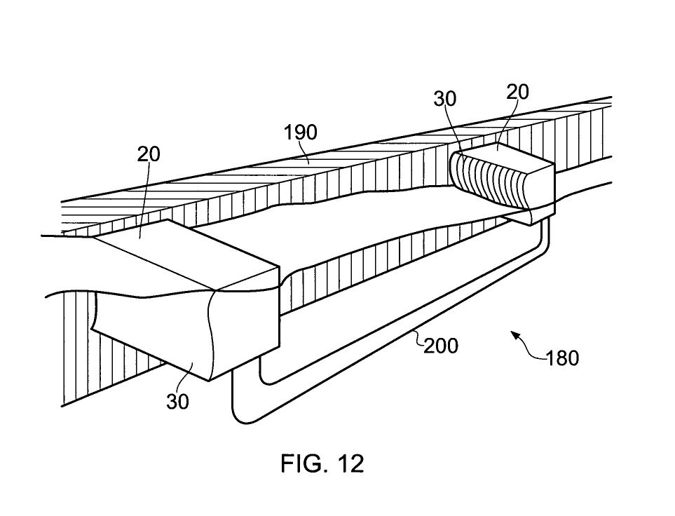

FIG. 12 is a perspective view of a wave energy conversion device according to a sixth embodiment of the present invention, being similar to the third embodiment of FIG. 9;

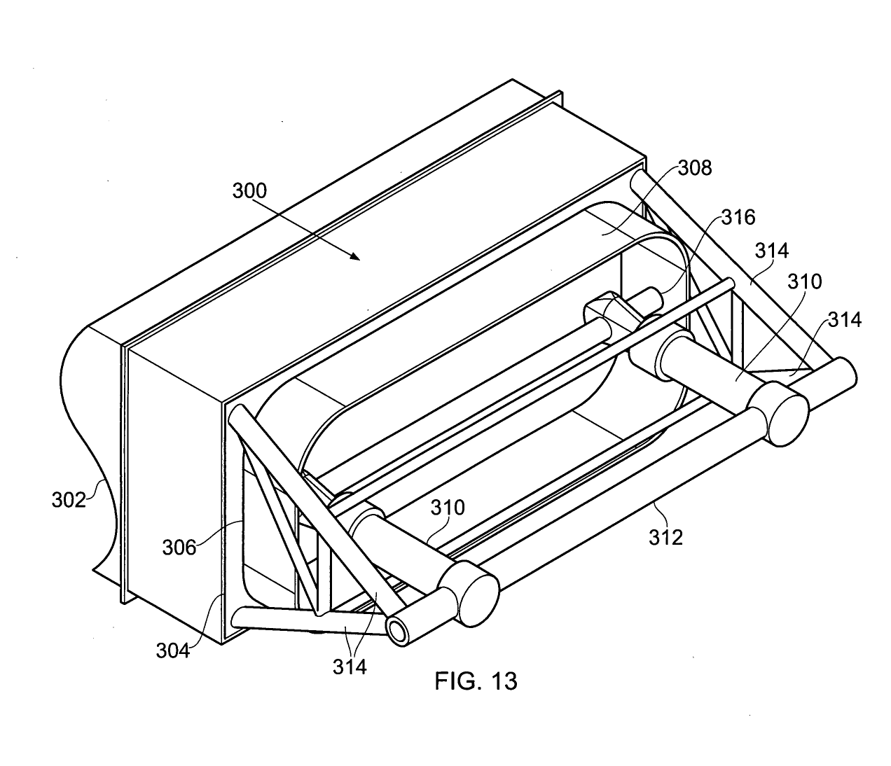

FIG. 13 is a perspective view of a wave energy conversion device according to a seventh embodiment of the present invention;

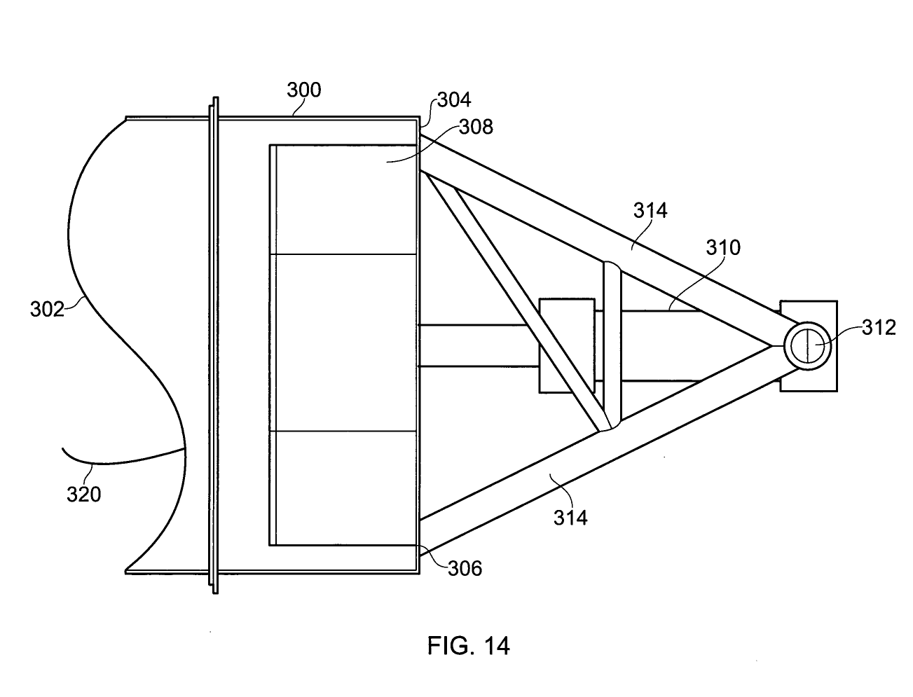

FIG. 14 is a side view of the wave energy conversion device of the seventh embodiment, in a first position, and

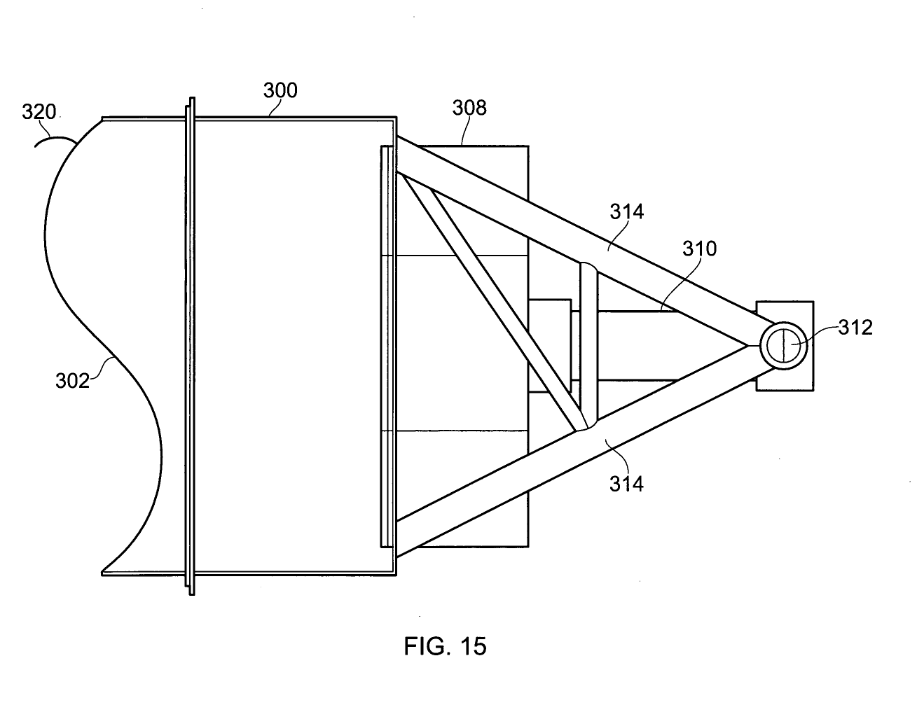

FIG. 15 is a side view of the wave energy conversion device according to the seventh embodiment, in a second position.

A wave energy conversion device 10 according to a first embodiment of the present invention is shown in FIG. 1. The device 10 comprises twelve interconnected cells 20 arranged in a ring which may be circular or oval. Each cell 20 is connected to a ring-like air duct (not shown), and each cell has, at an outer face, a diaphragm 30 which moves relative to the cell in response to changes in local sea level caused by waves. The movement of the diaphragms causes air to be pumped into and out of the air duct in order to spin the turbines (not shown) provided within it. The spinning turbines drive generators (not shown) in order to generate electricity.

The water level at the interface with the diaphragms 30 is indicated by line 40 and the water level inside the ring is indicated by line 50. As a result of wave action the water level 40 is higher at cells 20 to the left hand side of the figure than at those to the right hand side.

The diaphragms 30 of the cells on the left hand side are submerged over most of their height and are thus compressed by the water so that air is forced out of those air cells and into the air duct. On the other hand, the water level 40 is lower at the cells 20 to the right hand side of the figure. The diaphragms 30 of these cells are unaffected by water pressure over most of their height and are inflated by the internal air pressure caused by the transfer of air from the cells 20 of the left hand side of the figure to the air duct.

FIG. 2 shows a central vertical cross-section through an air cell of the prior art CLAM device. In FIG. 2 the same reference numerals as those used in respect of FIG. 1 are used. In addition, the air duct is indicated by reference numeral 25. FIG. 2 shows a range of computed diaphragm shapes calculated for different internal air pressure levels. These computed diaphragm shapes are typical of the diaphragm profiles during operation of the device. The constant water level assumed for the calculations is indicated by reference numeral 60.

Throughout the operation the diaphragm 30 assumes an ‘S’ shape. This is because at any point in time the pressure of the air on the inside of the diaphragm 30 is constant over its height while the pressure of the water on the outside of the diaphragm 30 increases with the cube of the depth. When a wave passes the device the change in water level causes a change in pressure across the diaphragm 30 which then causes the diaphragm to move.

The energy stored by the diaphragm 30 during its operational cycle is transferred to the air within the cell 20 and an air flow is set up in the air duct 30.

The present invention is derived from the prior art CLAM device, and includes a number of improvements over that known device. In particular, the present inventors have conducted extensive computer modelling studies in which the movement of the diaphragm over the duty cycle has been modelled. The computer model included as inputs the cyclical pressure in the sea at twenty points along the height of the diaphragm and the constant pressure at the exit from the turbine. Then, this data was used to calculate the shapes of the diaphragm and the vertical tensions in the cords. The lateral tension was estimated and fed back into the model as a further input.

An example of the output of the modelling studies is shown in FIG. 3. This figure shows four plot lines 70 which indicate the shape of the diaphragm at a mid-section at four different wave levels, i.e. at four different pressure distributions. The two trace lines 80 show the path followed by individual points on the diaphragm as it travels through the duty cycle. It can be seen from these plot lines 70 and trace lines 80 that the diaphragm not only moves in and out, as would be expected, but that the central region, at least, also moves up and down.

Another example of the output of the modelling studies is shown in FIG. 4. This figure includes several plot lines 70a-e which show the shape of the diaphragm at various positions in service. In the figure, the water is on the left hand side and the air within the cell is on the right hand side. Plot line 70c represents the diaphragm in a mid, or neutral, position. As discussed further below, this position provides a desirable shape for the attachment of the vertical edges of the diaphragm to the cell.

Plot lines 70b and 70d represent the typical maximum and minimum positions in typical operating conditions, while plot lines 70a and 70e represent the extreme positions encountered in service. Movements in excess of that defined by plot line 70a may be restricted by one or more horizontal bars on the water side, while movements in excess of that defined by plot line 70e may be prevented by features such as a saddle in the conduit leading to the turbine. Such provisions aid survival of the device during storm conditions.

Trace line 85 traces the movement of a central point of the diaphragm through a complete cycle. It can be seen from this trace line 85 that the diaphragm not only moves in and out, as would be expected, but that the central region, at least, also moves up and down.

Where a diaphragm is used with cords in a predetermined direction (normally the vertical direction when the diaphragm is used in a wave energy conversion device), the arrangement of the cords may vary across the diaphragm (in the transverse or horizontal direction). Moreover, the thickness of the material (usually rubber) forming the diaphragm may vary across the diaphragm in the transverse direction. In particular, it is preferable that the density of the cords decreases at the lateral edges of the diaphragm (i.e. the ‘S’ shaped edges), as imposed with the central region of the diaphragm, (i.e. the ‘S’ shaped edges), and also the thickness of the diaphragm increases at those edges. Thus, the diaphragm may be considered to have side zones each representing about 5 to 15% of the width (preferably 10%). The density of the cords in those side zones may be of 70% or less, preferably 50% or less of the density at the centre. There may be a transitional region in which the density decreases from that of the center to that at the sides. In addition, it is preferable that the thickness of the rubber increases by a factor of at least twice, preferably at least five or ten times from the center to the side zones. Thus, if the center of the diaphragm has rubber 5 to 10 mm thick, the sides of the diaphragm may have rubber about 50 mm thick. The thickness of the rubber at the sides assists with the bonding of the diaphragm to the frame. Again, the thickness of the diaphragm may vary smoothly between the sides and center.

The diaphragm 30 of the prior art CLAM device is attached to the cell via a straight-sided rectangular frame. Since the diaphragm must be longer in the vertical direction than the aperture it covers in order to be able to move in response to wave action, the diaphragm, which is reinforced with biased cords, is stretched laterally so that its height is reduced at the vertical edges in order for it to be fitted to the frame.

The present invention instead employs an attachment frame with ‘S’-shaped vertical sides, as shown in FIGS. 6 and 7. The computer modelling studies discussed above have shown that a desirable form for the ‘S’ shape is the plot line 90 shown in FIG. 5. This shape approximates the shape of the diaphragm in a ‘neutral position’. That is, the shape of a central vertical cross-section of the diaphragm when the device is in use and the pressure difference across the diaphragm is constant, e.g. in a calm sea. As can be seen from FIG. 6, this arrangement ensures that the vertical length of the diaphragm is longer than the height of the aperture it covers. Moreover, this arrangement ensures that energy losses due to stretching and distortion of the diaphragm along its vertical edges are minimised.

As shown in FIGS. 6 and 7, the diaphragm 30 is sandwiched between an outer frame 100 and an inner frame 110, the vertical edges of both of which are ‘S’-shaped. The edges of the diaphragm 30 are wrapped around a circular bead 140 which is clamped between the outer frame 100 and the inner frame 110. The bead 140 is not shown in FIG. 6, but line 130 indicates the path along which the bead is seated. The outer frame 110 is attached to the cell 20 via a frame seal 120.

It is envisaged that each of the diaphragms of the device will be in the region of 8 m high and 14 m wide. In use, three-quarters of the height of the diaphragm will typically be beneath the mean sea level, so that a height of approximately 2 m is exposed. The device will typically be deployed in regions with a water depth of around 50 m or more.

Second and third embodiments in which the device is fixed, rather than floating, are shown in FIGS. 8 and 9, respectively. The discussions above of the features shown in FIGS. 2 to 7 (discussed in relation to the first embodiment) are also relevant to the second and third embodiments.

FIG. 8 shows a wave energy conversion device 150 fixed to a jetty 160. The skilled reader will understand that the device may be fixed to any type of fixed structure, such as a harbour wall, wind turbine tower or tidal stream tower. The device 150 includes an air cell 20 with a diaphragm 30 which separates air within the air cell from the water surrounding the device. In the same way as in the first embodiment, the movement of water caused by wave action causes the diaphragm 30 to move in and out (and, to a lesser degree, up and down), and thereby force air through an air duct (not shown) which connects the air cell 20 with a compensation chamber 170. This movement of air causes a turbine (not shown) within the air duct to spin, and thereby generate energy.

Air is cycled between the air cell 20 and the compensation chamber 170 in the following way. Air discharged from the air cell 20 into the compensation chamber 170 causes a rise in pressure within the chamber. Thus, when a wave trough arrives at the diaphragm 30 the air in the chamber 170 is at a higher pressure than the air in the air cell 20 and so air flows back through the air duct from the chamber to the air cell. In FIG. 8 the compensation chamber 170 is shown with rigid walls, but the skilled reader will understand that the compensation could be provided by, for example, a flexible bladder.

FIG. 9 shows a wave energy device 180 fixed to a jetty 190. As with the second embodiment, the device 180 may be fixed to any fixed structure such as a harbour wall, wind turbine tower or tidal stream tower. The device 180 includes two air cells 20, each with a flexible diaphragm 30. The air cells 20 are connected by an air duct 200, within which there is a turbine (not shown). The air cells 20 are arranged in series in the direction of principle wave direction. It has been determined that the spacing between the air cells 20 should be controlled to one half of the wavelength in typical sea conditions, plus or minus a quarter wavelength. As the skilled reader will understand, the wavelength is dependent on the frequency of the waves, and to some extent the depth of the water, and so the optimum spacing must be calculated for each site based on the prevailing conditions.

As a result of this series arrangement, and as shown in FIG. 9, when one of the air cells 20 is exposed to the peak of a wave the other air cell 20 will, in normal conditions, be exposed to the trough of a wave. The effect of this is that air is channeled to and fro between the air cells 20 via the air duct 200, thus causing the turbine within the air duct to rotate.

In the embodiments discussed above, the water is shown as having a maximum height part-way up the side of the diaphragms. The difference between the maximum height of the water and the top of the cell is known as the “free board”. It has been found that it is preferable that the free board is zero, or is minimal, but free boards of up to 30% of the height of the cell will generally provide satisfactory operation. FIGS. 10 to 12 then illustrate and arrangement similar to FIGS. 1, 8 and 9, but in which the free board is minimal or zero. Apart from the difference in free board, these embodiments correspond to those of FIGS. 1, 8 and 9, and the same reference numerals are used to indicate corresponding parts.

In all the embodiments described above, a turbine is used to derive power from the air flow in the air duct leading from the air cell. FIGS. 13 to 15 illustrate another embodiment in which power-take-off is achieved by a piston arrangement.

Referring first to FIG. 13, a wave energy conversion device according to this further embodiment has an air cell 300 having a front face with an S-shaped diaphragm 302. The structure of the air cell 300 may be similar to that shown in FIG. 6, and so will not be described in more detail now.

However, in this embodiment, the back 304 of the cell has an aperture 306 therein, which aperture 306 may be considered to form a short duct leading from the cell 300, and which aperture 306 contains a piston 308. It can be seen that the aperture 306 has a size corresponding to the majority of the back phase 304, of the cell, and indeed it could form all that back face if necessary. The piston 308, is connected to hydraulic piston 310, which are mounted on a frame 312, connected via ‘V’-shaped legs 314 to the cell 300. Those hydraulic pistons 310 are connected to the piston 308 via a bar 316. Note that a seal is preferably provided between the piston 308 and the aperture 306, e.g. by a welding rubber seal, or lip or ring seals around the periphery of the piston 308. The operation of the wave energy conversion device of this embodiment will now be described with reference to FIGS. 14 and 15. In FIG. 14, the wave 320 is low on the diaphragm 302. In this position, the piston 308 extends to its maximum displacement through the aperture 306 towards the diaphragm 302. In the embodiment, The back of the piston 308 is then flushed with rear surface 304, of the cell 300, although this is not essential. The wave 302 rises, to the position shown in FIG. 15, the piston 308 is forced away from the diaphragm 302, out of the cell 300, thereby compressing the hydraulic pistons 310. This generates power for power-take-off, and also provides bolt damping for the piston 308 and a restoring force to restore the position to the position shown in FIG. 14, when the wave level falls again. High-pressure hydraulic power generated by the movement of the hydraulic pistons 310, may then be used to power a hydraulic motor which may be e.g. an electric generator.

As can be seen, in this embodiment the piston 308, which is driven by the movement of air in the cell 300 has a large area, so that a large force is generated on the high-pressure hydraulic pistons 310, when the piston 308 moves. It has been found that a variation of air pressure of 0.3 bar within the cell can be sufficient to generate a force of 3 MN on the hydraulic pistons 310. If the piston 308 has a stroke of e.g. 2 m, suitable energy can be obtained from such an arrangement powered by wave energy.

1-25. (canceled)

26. A wave energy conversion device, including:
a diaphragm supported by a frame, the frame and diaphragm together defining a cell for fluid;
a duct extending from the cell; and
a power-take-off device associated with the duct and arranged to respond to fluctuation of the fluid in the cell and/or duct;
wherein the diaphragm is capable of changing shape in response to a change in pressure difference across the diaphragm, the change of shape causing a consequent change in the fluid in the cell, and hence a response in the power-take-off device, at least one edge of the diaphragm being attached to the frame in a S-shaped configuration.

27. A wave energy conversion device according to claim 26, wherein said at least part of the diaphragm is one edge of the diaphragm, and an opposite edge of the diaphragm is also attached to the support structure along a second line of attachment, which second line of attachment is S-shaped.

28. A wave energy conversion device, including:
a diaphragm supported by a frame, the frame and diaphragm together defining a cell for fluid;
a duct extending from the cell; and
a power-take-off device associated with the duct and arranged to respond to fluctuation of the fluid in the cell and/or duct;
wherein the diaphragm is capable of changing shape in response to a change in pressure difference across the diaphragm, the change of shape causing a consequent change in the fluid in the cell, and hence a response in the power-take-off device, the diaphragm reinforced with a plurality of first cords aligned in a predetermined direction.

29. A wave energy conversion device according to claim 28, wherein, at least one edge of the diaphragm is attached to the frame in a S-shaped configuration

30. A wave energy conversion device according to claim 28, wherein the diaphragm is further reinforced by second elongate reinforcing means aligned in a different direction from the cords.

31. A wave energy conversion device according to claim 30, wherein the cords have a higher tensile strength and/or a higher modulus of elasticity than the second reinforcing means, and/or are substantially inextensible.

32. A wave energy conversion device according to claim 30, wherein the second reinforcing means comprises further cords.

33. A wave energy conversion device according to claim 30, wherein the angle between the cords and the second elongate reinforcing means is 80° or more.

34. A wave energy conversion device according to claim 26, wherein the power-take-off device comprises a turbine arranged to rotate in response to a fluid flow in the duct and/or the power-take-off device comprises a piston mounted in the duct.

35. A wave energy conversion device according to claim 26, wherein the duct is an aperture in a face of the cell.

36. A wave energy conversion device according to claim 28, wherein the cords extend in the vertical direction.

37. A wave energy conversion device according to claim 26, wherein the diaphragm is wider in the lateral direction joining the sides of the frame than it is in the perpendicular direction.

38. A wave energy conversion device according to claim 26, having a reservoir for fluid at an end of the duct remote from the cell.

39. The combination of a wave energy conversion device according to claim 26, and a second wave energy conversion device including a diaphragm supported by a frame, the frame and diaphragm together defining a cell for fluid;
a duct extending from the cell; wherein the diaphragm is capable of changing shape in response to a change in pressure difference across the diaphragm, the change of shape causing a consequent change in the fluid in the cell,
wherein the duct of the second energy conversion device is in fluid communication with the duct of said energy conversion device.

40. A wave energy conversion device according to claim 26 configured such that, in use, the diaphragm is at least partially immersed in water.

41. A wave energy conversion device according to claim 26, wherein the diaphragm is thicker at its edges than it is at a central part between these edges.

42. A wave energy conversion device according to claim 41, wherein the device is 4 to 12 times thicker at its edges than it is at central part.

43. A wave energy conversion device according to claim 28, wherein the power-take-off device comprises a turbine arranged to rotate in response to a fluid flow in the duct and/or the power-take-off device comprises a piston mounted in the duct.

44. A wave energy conversion device according to claim 28, wherein the diaphragm is wider in the lateral direction joining the sides of the frame than it is in the perpendicular direction.

45. A wave energy conversion device according to claim 28, having a reservoir for fluid at an end of the duct remote from the cell.

46. The combination of a wave energy conversion device according to claim 28, and a second wave energy conversion device including a diaphragm supported by a frame, the frame and diaphragm together defining a cell for fluid;
a duct extending from the cell; wherein the diaphragm is capable of changing shape in response to a change in pressure difference across the diaphragm, the change of shape causing a consequent change in the fluid in the cell,
wherein the duct of the second energy conversion device is in fluid communication with the duct of said energy conversion device.

47. A wave energy conversion device according to claim 28, wherein the diaphragm is thicker at its edges than it is at a central part between these edges.

48. A wave energy conversion device according to claim 28, wherein the duct is an aperture in a face of the cell.
